(19) United States
(12) Patent Application Publication
(10) Pub. No.: US 2021/0286109 A1
(43) Pub. Date: Sep. 16, 2021

(54) LIQUID LENSES AND ARTICLES WITH CONTACT PADS FOR CORROSION PROTECTION

(71) Applicant: CORNING INCORPORATED, CORNING, NY (US)

(72) Inventor: INES WYRSTA, SANTA BARBARA, CA (US)

(21) Appl. No.: 17/199,560

(22) Filed: Mar. 12, 2021

Related U.S. Application Data
(60) Provisional application No. 62/990,225, filed on Mar. 16, 2020.

(51) Int. Cl. G02B 3/14; G02B 26/00

(52) U.S. Cl. CPC G02B 3/14; G02B 26/005

(57) ABSTRACT

A liquid lens article includes: a first substrate comprising a glass composition; a first electrode disposed on a first primary surface of the first substrate; and a second electrode disposed on a second primary surface of the first substrate, the second primary surface opposing the first primary surface. Each of the first electrode and the second electrode comprises an outer edge that is substantially covered by an edge barrier layer. Each electrode comprises a metal. Further, the edge barrier layer comprises an electrically insulating metal oxide or oxynitride.

### CROSS-REFERENCE TO RELATED APPLICATIONS

This application claims the benefit of priority under 35 U.S.C. § 119 of U.S. Provisional Application No. 62/990,225, filed Mar. 16, 2020, the content of which is incorporated herein by reference in its entirety.

### FIELD OF THE DISCLOSURE

The disclosure relates to liquid lenses and liquid lens articles configured for corrosion protection and, more particularly, to such liquid lenses and articles with contact pads configured and electrode structures configured for corrosion protection.

### BACKGROUND

Liquid lenses generally include two different liquids disposed within a chamber. Varying an electric field applied to the liquids can vary the wettability of one of the liquids relative to walls of the chamber, which has the effect of varying the shape of a meniscus formed between the two liquids. Further, in various applications, changes to the shape of the meniscus can drive controlled changes to the focal length of the lens.

In typical liquid lens products, electrical contacts and interconnections are made to contact pads for resistive or capacitive control schemes. These interconnections can result in exposed metal with a risk for electrolytic, galvanic and/or chemical corrosion, particularly as the liquid lens is subjected to high temperature and/or high humidity operation. Some approaches for corrosion protection, as employed in semiconductor packaging, involve encapsulating most or all of the device. However, in liquid lens applications, encapsulation of the device is not viable as the device also has various optical requirements which would be influenced by the encapsulation scheme.

Accordingly, there is a need for liquid lens and liquid lens article configurations configured for corrosion protection, particularly at the electrode structures and contact pads. There is also a need for such corrosion protection schemes that are amenable to low manufacturing cost that do not substantially influence other performance characteristics of the liquid lens device.

### SUMMARY OF THE DISCLOSURE

According to some aspects of the present disclosure, a liquid lens article is provided that includes: a first substrate comprising a glass composition; a first electrode disposed on a first primary surface of the first substrate; and a second electrode disposed on a second primary surface of the first substrate, the second primary surface opposing the first primary surface. Each of the first electrode and the second electrode comprises an outer edge that is substantially covered by an edge barrier layer. Each electrode comprises a metal. Further, the edge barrier layer comprises an electrically insulating metal oxide or oxynitride.

According to other aspects of the present disclosure, a liquid lens is provided that includes: a first substrate comprising a glass composition; a first electrode disposed on a first primary surface of the first substrate; a second electrode disposed on a second primary surface of the first substrate, the second primary surface opposing the first primary surface; a second substrate comprising a bore and bonded to the first substrate at a bond defined at least in part by the first electrode; a cavity defined at least in part by the bore in the second substrate, the bond, and the first substrate; and a first liquid and a second liquid disposed within the cavity. Each of the first electrode and the second electrode comprises an outer edge that is substantially covered by an edge barrier layer. Each electrode comprises a metal. Further, the edge barrier layer comprises an electrically insulating metal oxide or oxynitride.

According to other aspects of the present disclosure, a method of making a liquid lens article is provided that includes: depositing an electrode layer on a first and second primary surface of a first substrate comprising a glass composition, the second primary surface opposing the first primary surface; patterning the electrode layer to define a first and a second electrode disposed on the respective first or second primary surface of the substrate, wherein each of the first electrode and the second electrode comprises an outer edge; and depositing an edge barrier layer over the first and second electrode, wherein the barrier layer substantially covers the outer edge of the electrodes. Each electrode comprises a metal. The edge barrier layer comprises an electrically insulating metal oxide or oxynitride. Further, the metal of each electrode is selected from the group consisting of Cr, Mo, Au, Ag, Ni, Ti, Cu, Al, V, W, Zr, indium tin oxide (ITO), indium zinc oxide (IZO), a Ni/V alloy, a Ni/Au alloy, a Au/Si alloy, a Cu/Ni alloy, other alloys thereof, and combinations thereof.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a schematic, cross-sectional view of a liquid lens article, according to embodiments of the disclosure;

FIGS. 2A-2C are schematic, cross-sectional views of liquid lens articles and liquid lenses, according to embodiments of the disclosure;

FIG. 3 is a schematic flow chart of a method of making a liquid lens article, according to embodiments of the disclosure; and

FIG. 4 is a series of box plots of measured parameters of liquid lenses with capacitive and direct, resistive interconnections, according to embodiments of the disclosure.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

In various embodiments of the disclosure, liquid lens articles and liquid lenses are provided with electrode structures and/or metal contact pads that employ edge barrier layers for corrosion protection. These edge barrier layers can employ an electrically insulating metal oxide or oxynitride. Some embodiments of the liquid lens articles and liquid lenses include capacitive interconnection configurations that provide corrosion protection. In such embodiments, the electrodes are coupled through a dielectric layer, which provides a physical barrier to protect the electrodes from corrosion. In embodiments with direct, physical interconnection schemes, the outer layer of the metal contact pad can include one or more metals, e.g., Au, Ti/Au, and Cr/Au, with low contact resistance and corrosion resistance.

These configurations offer several advantages over conventional liquid lens articles and lenses. For example, embodiments of these articles and lenses can possess corrosion resistance through elimination of a direct current path to their electrode structures. Embodiments of these articles and lenses can demonstrate corrosion resistance through the elimination or mitigation of corrosion at the edges of their electrodes through the use of the edge barrier layers of the disclosure. As another example, articles and lenses of the disclosure can be configured with barrier layers that encapsulate their metal contact pads, which can enhance their corrosion resistance. Further, the barrier layers of some embodiments of the articles and lenses of the disclosure offer improved scratch resistance for their contact pads, facilitating more reliable interconnection capabilities. As a further example, embodiments of the liquid lens articles and liquid lenses of the disclosure exhibit corrosion resistance through configurations that offer manufacturing cost savings, e.g., through the reduction or elimination of wet or dry etch steps, lower process complexity, and other aspects.

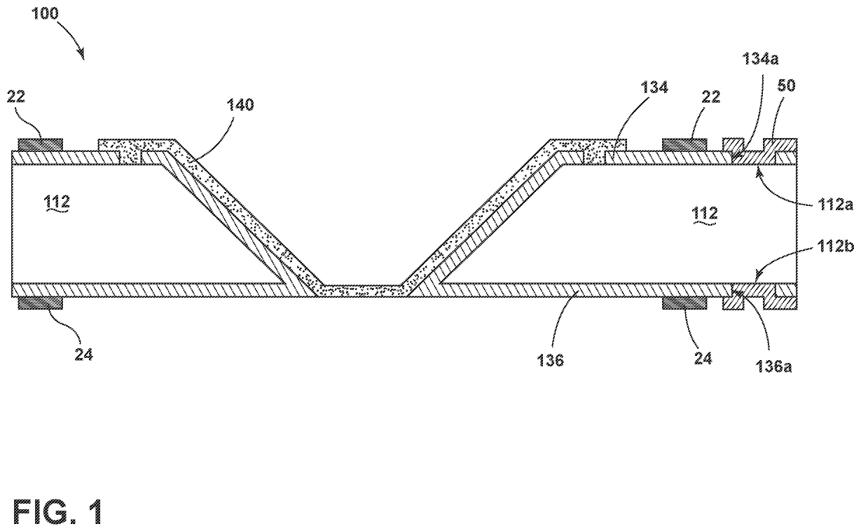

Referring to FIG. 1, a liquid lens article 100 is provided that includes: a first substrate 112; a first electrode 134 disposed on a first primary surface 112a of the substrate; and a second electrode 136 disposed on a second primary surface 112b, which opposes the first primary surface 112a. Each of the first electrode 134 and the second electrode 136 comprises an outer edge 134a, 136a that is substantially covered by an edge barrier layer 50. Further, each electrode 134, 136 includes one or more metals, and the edge barrier layer 50 includes an electrically insulating metal oxide or metal oxynitride. In some embodiments, the second electrode 136 is insulated from the first electrode 134 via an insulating layer 140. The insulating layer 140 can include one or more of polytetrafluoroethylene (PTFE), parylene, silane-containing parylene, or another polymeric or non-polymeric electrically insulating material. More generally, the edge barrier layer 50 ensures that the outer edge 134a, 136b of the first and second electrodes 134, 136 is protected from electrolytic, galvanic and/or chemical corrosion.

In embodiments of the liquid lens article 100 depicted in FIG. 1, the metal or metals of each electrode 134, 136 is selected from the group consisting of Cr, Mo, Au, Ag, Ni, Ti, Cu, Al, V, W, Zr, indium tin oxide (ITO), indium zinc oxide (IZO), a Ni/V alloy, a Ni/Au alloy, a Au/Si alloy, a Cu/Ni alloy, other alloys thereof, and combinations thereof. In some embodiments, each of the electrodes 134, 136 includes one or more of Cr, Mo, Ni, Ti, Cu, V, W, Zr, ITO, IZO, a Ni/V alloy, a Ni/Au alloy, a Au/Si alloy, a Cu/Ni alloy, other alloys thereof, and combinations thereof. According to an implementation of the liquid lens article 100 depicted in FIG. 1, the article further includes a first metal contact pad 22 disposed over the first electrode 134 and a second metal contact pad 24 disposed over the second electrode 136. In these implementations, the metal pads 22, 24 include one or more of Au, Ag, Pt, Cu, Ti/Au, Cr/Au, alloys thereof, a metal conductive epoxy (e.g., Ag-containing epoxy), and combinations thereof. An advantage of these embodiments is that the metal of each of these contact pads 22, 24 includes one or more metals, e.g., Au, Ti/Au, and Cr/Au, that offers low contact resistance and corrosion resistance.

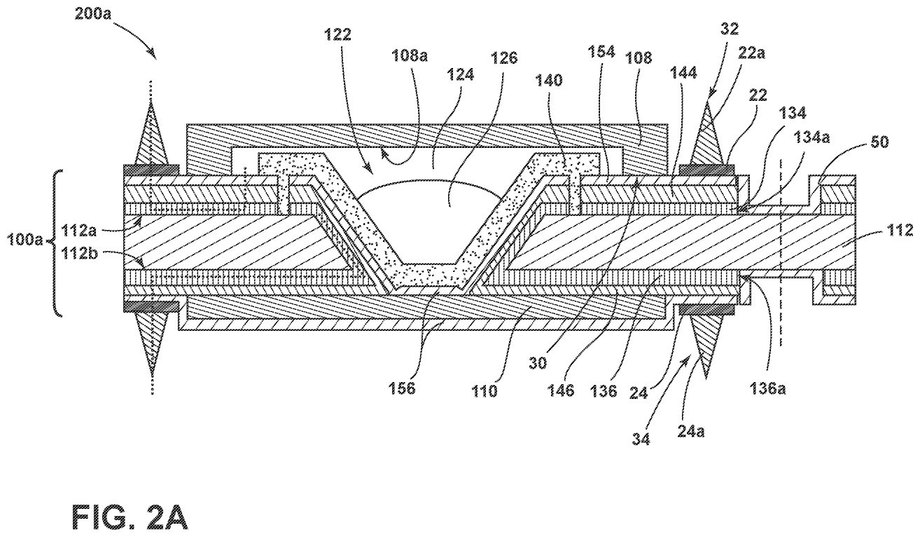

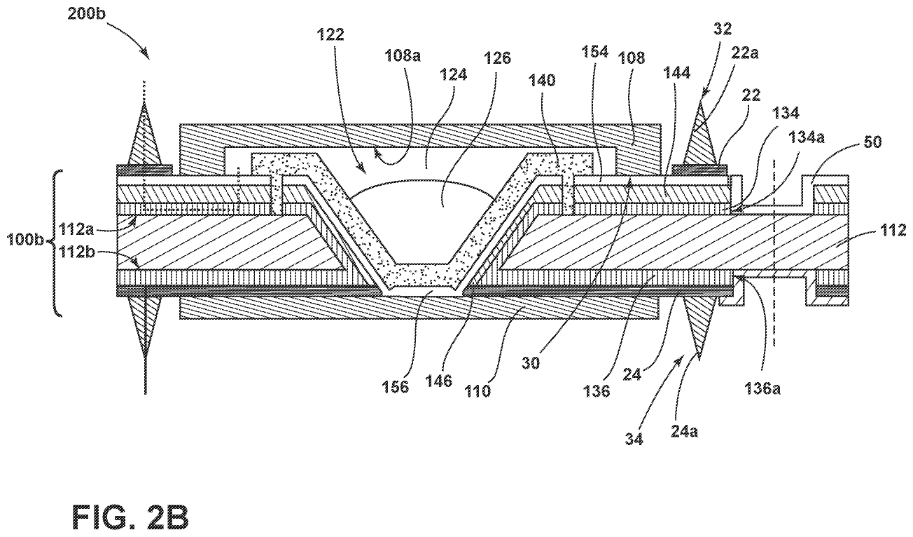

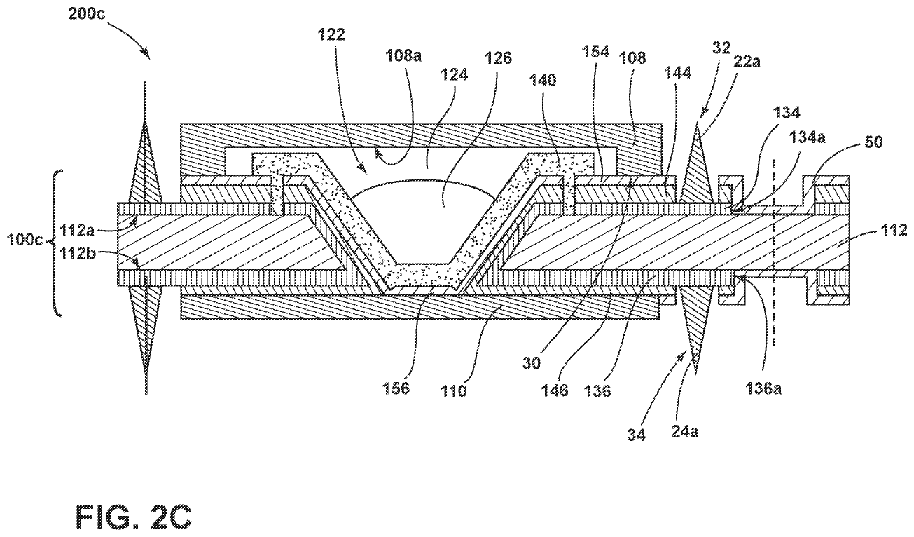

Referring now to FIG. 2A, a liquid lens article 100a (as part of a liquid lens 200a) is depicted in exemplary form. Unless otherwise noted, the liquid lens article 100a shown in FIG. 2A is substantially similar to the liquid lens article 100 depicted in FIG. 1, with like-numbered elements having the same, or a substantially similar, structure and function, including the presence of the edge barrier layer 50 over the outer edges 134a, 136a of the respective first and second electrodes 134, 136. Further, the liquid lens article 100a includes: a first antireflective (AR) structure 144 disposed on the first electrode 134; a second AR structure 146 disposed on the second electrode 136; a first barrier layer 154 disposed on the first AR structure 144; and a second barrier layer 156 disposed on the second AR structure 146. In implementations of the liquid lens article 100a, each of the first and second AR structures 144, 146 includes a metal layer and a metal oxide layer. In some embodiments of the liquid lens article 100a, each of the first and second barrier layers 154, 156 includes an electrically insulating metal oxide or metal oxynitride. One benefit offered by the liquid lens article 100a is that the presence of the AR structures 144, 146 and barrier layers 154, 156 over the respective first and second electrodes 134, 136 allows for a capacitive coupling to be made to these electrodes. This level of insulating layer coverage over the electrodes 134, 136 provides them with corrosion protection, and also provides a manufacturing benefit in the sense that the electrodes need not be etched or patterned prior to electrical connection.

According to some embodiments of the liquid lens article 100a shown in FIG. 2A, the metal layer (or layers) of the AR structures 144, 146 can include one or more of Cr, Mo, Ni, Ti, Cu, V, W, Zr, ITO, IZO, a Ni/V alloy, a Ni/Au alloy, a Au/Si alloy, a Cu/Ni alloy, other alloys thereof, and combinations thereof. Further, the metal oxide layer (or layers) of the AR structures 144, 146 can include CrOₓN_{y}, transparent conductive oxides (TCOs), e.g., ITO, IZO, aluminum-doped zinc oxide (AZO), gallium-doped zinc oxide (GZO), boron-doped zinc oxide (BZO), fluorine-doped tin oxide (FTO), zinc tin oxide (ZTO), titanium niobium oxide (TNO), indium gallium zinc oxide (IGZO), and combinations thereof. In some implementations, the AR structures 144, 146 can include one of the following layer structures: Cr/CrOₓN_{y}; CrOₓN_{y}/Cr/CrOₓN_{y}; and various multi-layer structures comprising Cr and CrOₓN_{y}. According to embodiments of the liquid lens article 100a shown in FIG. 2A, the first and second barrier layers 154, 156 can include one or more of SiO₂, Al₂O₃, SiOₓN_{y}, CrOₓN_{y}, HfO₂, and multi-layer structures of these metal oxides. In some implementations, the barrier layers 154, 156 can be one or more of SiO₂ and Al₂O₃.

Referring now to FIG. 2B, a liquid lens article 100b (as part of a liquid lens 200b) is depicted in exemplary form. Unless otherwise noted, the liquid lens article 100b shown in FIG. 2B is substantially similar to the liquid lens article 100 depicted in FIG. 1, with like-numbered elements having the same, or a substantially similar, structure and function, including the presence of the edge barrier layer 50 over the outer edges 134a, 136a of the respective first and second electrodes 134, 136. Further, the liquid lens article 100b includes: a first antireflective (AR) structure 144 disposed on the first electrode 134; and a first barrier layer 154 disposed on the first AR structure 144. In implementations of the liquid lens article 100b, the first AR structure 144 includes a metal layer and a metal oxide layer. In some embodiments, the liquid lens article 100b also includes a second barrier layer 156 disposed on at least a portion of the second AR structure 146, and the second AR structure 146 is disposed over a portion of the second electrode 136. In some embodiments of the liquid lens article 100b, the first barrier layer 154 includes an electrically insulating metal oxide or metal oxynitride. Further, some embodiments of the liquid lens article 100b include an AR structure 144 and a barrier layer 154 with any of the materials specified earlier for these layers in the liquid lens article 100a shown in FIG. 2A. One benefit offered by the liquid lens article 100b is that the presence of the AR structure 144 and barrier layer 154 over the first electrode 134 allows for a capacitive coupling to be made to this electrode. On the other hand, a direct, resistive connection can be made to the second electrode 136 in the article 100b. This level of insulating layer coverage over the electrode 134 provides it with corrosion protection, and also provides a manufacturing benefit in the sense that this electrode need not be etched or patterned prior to electrical connection. Furthermore, the direct, resistive connection capability to the second electrode 136 allows it to be used in devices requiring or otherwise benefiting from direct resistive control.

Referring now to FIG. 2C, a liquid lens article 100c (as part of a liquid lens 200c) is depicted in exemplary form. Unless otherwise noted, the liquid lens article 100c shown in FIG. 2C is substantially similar to the liquid lens article 100 depicted in FIG. 1, with like-numbered elements having the same, or a substantially similar, structure and function, including the presence of the edge barrier layer 50 over the outer edges 134a, 136a of the respective first and second electrodes 134, 136. Further, the liquid lens article 100c includes: a first antireflective (AR) structure 144 disposed on the first electrode 134; a second AR structure 146 disposed on the second electrode 136; and a first barrier layer 154 disposed on the first AR structure 144. In some embodiments, the liquid lens article 100c also includes a second barrier layer 156 disposed on at least a portion of the second AR structure 146. In implementations of the liquid lens article 100c, each of the first and second AR structures 144, 146 includes a metal layer and a metal oxide layer. In some embodiments of the liquid lens article 100c, each of the first and second barrier layers 154, 156 includes an electrically insulating metal oxide or metal oxynitride. Further, some embodiments of the liquid lens article 100c include AR structures 144, 146 and barrier layers 154, 156 with any of the materials specified earlier for these layers in the liquid lens article 100a shown in FIG. 2A. One benefit offered by the liquid lens article 100c is that a direct, resistive connection can be made to each of the first and second electrodes 134, 136. The direct, resistive connection capability to the first and second electrodes 134, 136 allows them to be used in devices requiring or otherwise benefiting from direct resistive control of both electrodes. Notably, corrosion protection of these electrodes is also afforded by the edge barrier layer 50 over the outer edges 134a, 136a of these electrodes.

According to embodiments of the liquid lens articles 100a-100c depicted in FIGS. 2A-2C, the thickness of each of the first and second electrodes 134, 136 can range from 10 nm to 150 nm, from 25 nm to 150 nm, from 50 nm to 150 nm, from 10 nm to 50 nm, and all thickness ranges and thicknesses between the foregoing ranges. For example, the thickness of each of the first and second electrodes 134, 136 can be 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, and all thickness values between the foregoing values. In some embodiments, the thickness of each of the first and second AR structures 144, 146 can range from 10 nm to 100 nm, from 25 nm to 100 nm, from 50 nm to 100 nm, from 10 nm to 50 nm, and all thickness ranges and thicknesses between the foregoing ranges. For example, the thickness of each of the first and second AR structures 144, 146 can be 10 nm, 20 nm, 30 nm, 40 nm, 50 nm, 60 nm, 70 nm, 80 nm, 90 nm, 100 nm, and all thickness values between the foregoing values. In some implementations, the total thickness of the first electrode 134 and AR structure 144, and total thickness of the second electrode 136 and AR structure 146 can range from 10 nm to 200 nm, from 25 nm to 200 nm, from 50 nm to 200 nm, from 10 nm to 150 nm, from 25 nm to 150 nm, from 50 nm to 150 nm, from 10 nm to 50 nm, and all thickness ranges and thicknesses between the foregoing ranges.

In some embodiments of the liquid lens articles 100a-100c, the first barrier layer 154 and the second barrier layer 156 have a thickness from 10 nm to 5000 nm, from 25 nm to 5000 nm, from 50 nm to 5000 nm, from 100 nm to 5000 nm, from 150 nm to 5000 nm, from 200 nm to 5000 nm, from 250 nm to 5000 nm, from 500 nm to 5000 nm, from 1000 nm to 5000 nm, from 250 nm to 4000 nm, from 500 nm to 4000 nm, from 1000 nm to 4000 nm, from 250 nm to 3000 nm, from 500 nm to 3000 nm, from 1000 nm to 3000 nm, from 1500 nm to 3000 nm, from 2000 nm to 3000 nm, and all thickness ranges and thicknesses between the foregoing ranges. For example, the thickness of each of the first and second barrier layers 154, 156 can be 10 nm, 20 nm, 30 nm, 40 nm, 50 nm, 60 nm, 70 nm, 80 nm, 90 nm, 100 nm, 150 nm, 200 nm, 300 nm, 400 nm, 500 nm, 600 nm, 700 nm, 800 nm, 900 nm, 1000 nm, 1500 nm, 2000 nm, 3000 nm, 4000 nm, 5000 nm, and all thickness values between the foregoing values. In some implementations of the liquid lens articles 100a-100c depicted in FIGS. 2A-2C, along with liquid lens article 100 depicted in FIG. 1, the metal contact pads 22, 24 each have a thickness from 5 nm to 150 nm, from 5 nm to 125 nm, from 5 nm to 100 nm, from 5 nm to 75 nm, from 10 nm to 150 nm, from 10 nm to 125 nm, from 10 nm to 100 nm, from 10 nm to 75 nm, from 20 nm to 150 nm, from 20 nm to 125 nm, from 20 nm to 100 nm, from 20 nm to 75 nm, from 30 nm to 150 nm, from 30 nm to 125 nm, from 30 nm to 100 nm, from 30 nm to 75 nm, and all thickness ranges and thicknesses between the foregoing ranges. For example, the thickness of each of the first and second contact pads 22, 24 can be 5 nm, 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, and all thickness values between the foregoing values.

Referring again to FIGS. 2A-2C, liquid lenses 200a-c are provided, each of which includes: a first substrate 112; a first electrode 134 disposed on a first primary surface 112a of the first substrate; a second electrode 136 disposed on a second primary surface 112b of the first substrate, the second primary surface 112b opposing the first primary surface 112a; and a second substrate 108 comprising a bore 108a and bonded to the first substrate 112 at a bond 30 defined at least in part by the first electrode 134. The liquid lenses 200a-200c also include: a cavity 122 defined at least in part by the bore 108a in the second substrate 108, the bond 30, and the first substrate 112; and a first liquid 124 and a second liquid 126 disposed within the cavity 122. Each of the first electrode 134 and the second electrode 136 comprises a respective outer edge 134a, 136a that is substantially covered by an edge barrier layer 50. Each electrode 134, 136 comprises a metal. Further, the edge barrier layer 50 comprises an electrically insulating metal oxide or oxynitride. In some embodiments, the second electrode 136 is insulated from the first electrode 134 via an insulating layer 140. The insulating layer 140 can include one or more of polytetrafluoroethylene (PTFE), parylene, silane-containing parylene, or another polymeric or non-polymeric electrically insulating material. More generally, the edge barrier layer 50 of the liquid lenses 200a-200c ensures that the outer edge 134a, 136b of the first and second electrodes 134, 136 is protected from electrolytic, galvanic and/or chemical corrosion.

In embodiments of the liquid lenses 200a-200c depicted in FIGS. 2A-2C, the metal or metals of each electrode 134, 136 is selected from the group consisting of Cr, Mo, Au, Ag, Ni, Ti, Cu, Al, V, W, Zr, indium tin oxide (ITO), indium zinc oxide (IZO), a Ni/V alloy, a Ni/Au alloy, a Au/Si alloy, a Cu/Ni alloy, other alloys thereof, and combinations thereof. In some embodiments, each of the electrodes 134, 136 includes one or more of Cr, Mo, Ni, Ti, Cu, V, W, Zr, ITO, IZO, a Ni/V alloy, a Ni/Au alloy, a Au/Si alloy, a Cu/Ni alloy, other alloys thereof, and combinations thereof. According to an implementation of the liquid lenses 200a-200c depicted in FIGS. 2A-2C, the lens further includes a first metal contact pad 22 disposed near the outer edge 134a (and over the first electrode 134) and a second metal contact pad 24 disposed near the outer edge 136a (and over the second electrode 136). Further, these metal contact pads 22, 24 are in electrical communication with the respective first and second electrodes 134, 136. In these implementations, the metal pads 22, 24 include one or more of Au, Ag, Pt, Cu, Ti/Au, Cr/Au, alloys thereof, a metal conductive epoxy (e.g., Ag-containing epoxy), and combinations thereof. An advantage of these embodiments is that the metal of each of these contact pads 22, 24 includes one or more metals, e.g., Au, Ti/Au, and Cr/Au, that offers low contact resistance and corrosion resistance.

Referring now to FIG. 2A, a liquid lens 200a is depicted in exemplary form, as including the liquid lens article 100a described above and the edge barrier layer 50 over the outer edges 134a, 136a of the respective first and second electrodes 134, 136. Further, the liquid lens 200a includes: a first AR structure 144 disposed on the first electrode 134; a second AR structure 146 disposed on the second electrode 136; a first barrier layer 154 disposed on the first AR structure 144; and a second barrier layer 156 disposed on the second AR structure 146. In implementations of the liquid lens 200a, each of the first and second AR structures 144, 146 includes a metal layer and a metal oxide layer. In some embodiments of the liquid lens 200a, each of the first and second barrier layers 154, 156 includes an electrically insulating metal oxide or metal oxynitride.

According to an embodiment of the liquid lens 200a depicted in FIG. 2A, the liquid lens can include: a first interconnection 32 to a portion of the first electrode 134 through the first AR structure 144 and the first barrier layer 154; and a second interconnection 34 to a portion of the second electrode 136 through the second AR structure 146 and the second barrier layer 156. In such embodiments, each of the first and second interconnections 32, 34 includes a capacitive coupling between a respective conductive epoxy 22a, 24a (e.g., a Ag-containing epoxy, a graphite-containing epoxy) and the respective first or second electrode 134, 136. In some implementations, adhesion promoters, as understood by those skilled in the field of the disclosure, can be employed to improve the adhesion between the epoxy 22a, 24a to the respective metal pads 22, 24. One benefit offered by embodiments of the liquid lens 200a depicted in FIG. 2A is that the presence of the AR structures 144, 146 and barrier layers 154, 156 over the respective first and second electrodes 134, 136 allows for a capacitive coupling to be made to these electrodes, e.g., by virtue of the interconnections 32, 34. This level of insulating layer coverage over the electrodes 134, 136 provides them with corrosion protection, and also provides a manufacturing benefit in the sense that the electrodes need not be etched or patterned prior to electrical connection.

Referring now to FIG. 2B, a liquid lens 200b is depicted in exemplary form, as including the liquid lens article 100b and the edge barrier layer 50 over the outer edges 134a, 136a of the respective first and second electrodes 134, 136. Further, the liquid lens 200b includes: a first AR structure 144 disposed on the first electrode 134; and a first barrier layer 154 disposed on the first AR structure 144. In implementations of the liquid lens 200b, the first AR structure 144 includes a metal layer and a metal oxide layer. In some embodiments, the liquid lens 200b also includes a second barrier layer 156 disposed on at least a portion of the second AR structure 146, and the second AR structure 146 disposed over a portion of the second electrode 136. In some embodiments of the liquid lens 200b, the first barrier layer 154 includes an electrically insulating metal oxide or metal oxynitride. Further, some embodiments of the liquid lens 200b include an AR structure 144 and a barrier layer 154 with any of the materials specified earlier for these layers in the liquid lens 200a shown in FIG. 2A.

According to an embodiment of the liquid lens 200b depicted in FIG. 2B, the liquid lens can include: a first interconnection 32 to a portion of the first electrode 134 through the first AR structure 144 and the first barrier layer 154; and a second interconnection 34 joined directly to a portion of the second electrode 136 (or pad 24, if present). In such embodiments, the first interconnection 32 includes a capacitive coupling between the conductive epoxy 22a and the first electrode 134, and the second interconnection 34 includes a direct, resistive coupling between the conductive epoxy 24a and the second electrode 136 (or pad 24, if present). In some implementations, adhesion promoters, as understood by those skilled in the field of the disclosure, can be employed to improve the adhesion between the epoxy 22a, 24a to the respective metal pads 22, 24 and/or second electrode 136. One benefit offered by the liquid lens 200b is that the presence of the AR structure 144 and barrier layer 154 over the first electrode 134 allows for a capacitive coupling to be made to this electrode, e.g., as through interconnection 32. On the other hand, a direct, resistive connection can be made to the second electrode 136 (or pad 24, if present) in the liquid lens 200b, e.g., as through the second interconnection 34. This level of insulating layer coverage over the electrode 134 provides it with corrosion protection, and also provides a manufacturing benefit in the sense that this electrode need not be etched or patterned prior to electrical connection. Furthermore, the direct, resistive connection capability to the second electrode 136 allows it to be used in devices requiring or otherwise benefiting from direct resistive control.

Referring now to FIG. 2C, a liquid lens 200c is depicted in exemplary form, as including the liquid lens article 100c, and the edge barrier layer 50 over the outer edges 134a, 136a of the respective first and second electrodes 134, 136. Further, the liquid lens 200c includes: a first antireflective (AR) structure 144 disposed on the first electrode 134; a second AR structure 146 disposed on the second electrode 136; and a first barrier layer 154 disposed on the first AR structure 144. In some embodiments, the liquid lens 200c also includes a second barrier layer 156 disposed on at least a portion of the second AR structure 146. In implementations of the liquid lens 200c, each of the first and second AR structures 144, 146 includes a metal layer and a metal oxide layer. In some embodiments of the liquid lens 200c, each of the first and second barrier layers 154, 156 includes an electrically insulating metal oxide or metal oxynitride. Further, some embodiments of the liquid lens 200c include AR structures 144, 146 and barrier layers 154, 156 with any of the materials specified earlier for these layers in the liquid lens article 100a shown in FIG. 2A.

According to an embodiment of the liquid lens 200c depicted in FIG. 2C, the liquid lens can include: a first interconnection 32 joined directly to a portion of the first electrode 134 through the first AR structure 144 and the first barrier layer 154; and a second interconnection 34 joined directly to a portion of the second electrode 136 (or pad 24, if present). In such embodiments, the first and second interconnections 32, 34 include a direct, resistive coupling between respective conductive epoxy 22a, 24a and the respective first or second electrode 134, 136. One benefit offered by the liquid lens 100c is that a direct, resistive connection can be made to each of the first and second electrodes 134, 136. The direct, resistive connection capability to the first and second electrodes 134, 136, e.g., through the interconnections 32, 34, allows them to be used in devices requiring or otherwise benefiting from direct resistive control of both electrodes. Notably, corrosion protection of these electrodes is also afforded by the edge barrier layer 50 over the outer edges 134a, 136a of these electrodes.

In some embodiments of the liquid lenses 200a-200c depicted in FIGS. 2A-2C, the liquid lens has a third substrate 110, which can be bonded to the first substrate 112 according to a bond (not shown) with a similar configuration to bond 30, which joins the first substrate 112 and the second substrate 108. In these embodiments, the first substrate 112, the second substrate 108, the third substrate 110, and the insulating layer 140 can define the cavity 122. In other words, the cavity 122 is disposed between the second substrate 108, the first substrate 112 and the third substrate 110. In implementations of the liquid lens 100, the first substrate 112, the second substrate 108, and the third substrate 110 are all transparent (e.g., with an optical transmittance of at least 70%) to the wavelength of a laser (e.g., 1060 nm for an infrared CO₂ laser) employed for liquid lens dicing operations. A small gap (not illustrated) may separate each of the first substrate 112, second substrate 108 and third substrate 110 from their adjacent layer.

In embodiments of the liquid lenses 200a-200c depicted in FIGS. 2A-2C, the first, second and third substrates 108, 110, 112 can exhibit a sufficient transparency to enable passage of the image light. For example, the substrates 108, 110, 112 can comprise a polymeric, a glass, ceramic (e.g., a silicon wafer), or glass-ceramic material. Because image light can pass through the cavity 122 in the center of the first substrate 112, in some embodiments, the first substrate 112 need not be transparent to the image light. However, the first substrate 112 can be transparent to the image light. As noted earlier, the first substrate 112, the second substrate 108, and the third substrate 110 can all be transparent to the wavelength of a laser employed for liquid lens dicing operations. The first substrate 112, according to some embodiments, can comprise a metallic, polymeric, a glass, ceramic, or glass-ceramic material. In the illustrated embodiments of the liquid lenses 200a-200C shown in FIGS. 2A-2C, each of the substrates 108, 110 and 112 comprise a glass composition.

Referring again to FIG. 2A-2C, each of the liquid lenses 200a-200c includes a first liquid 124 and a second liquid 126 disposed within the cavity 122. Because of the properties of the first liquid 124 and the second liquid 126, the first liquid 124 and the second liquid 126 separate from one another at an interface. In embodiments, the first liquid 124 and second liquid 126 are non-miscible or substantially non-miscible. The first liquid 124 can be a polar liquid or a conducting liquid. Additionally, or alternatively, the second liquid 126 can be a non-polar liquid or an insulating liquid. The first liquid 124 can be substantially immiscible with, and has a different refractive index than, the second liquid 126, such that the interface between the first liquid 124 and the second liquid 126 forms, thus making a lens. The first liquid 124 and the second liquid 126 can have substantially the same density, which can help to avoid changes in the shape of the interface as a result of changing the physical orientation of the liquid lens 200a-c (e.g., as a result of gravitational forces).

Referring again to the liquid lens 200a-200c depicted in FIGS. 2A-2C, the external surfaces of the second and third substrates 108, 110 can be substantially planar, as also illustrated in these figures. Thus, although the liquid lens 200a-200c can function as a lens (e.g., by refracting image light passing through the interface between the first and second liquids 124, 126), the external surfaces of the liquid lens can be flat, e.g., as distinct from the curved outer surfaces of a typical conventional, convex fixed lens. In other embodiments of the liquid lens 200a-200c, the external surfaces of the second substrate and/or the third substrate, respectively, can be curved (e.g., concave or convex). Thus, the liquid lens 200a-200c can comprise an integrated fixed lens.

Referring again to the liquid lenses 200a-200c depicted in FIGS. 2A-2C, either of or both of the first electrode 134 and the second electrode 136 can comprise two or more layers, some of which can be conductive. The first electrode 134 functions as a common electrode in electrical communication with the first liquid 124. The second electrode 136 functions as a driving electrode. The second electrode 136 is disposed on the through hole of the first substrate 112 as well as between the first substrate 112 and the third substrate 110.

Once again referring to the liquid lenses 200a-200c depicted in FIGS. 2A-2C, either or both of the first electrode 134 and the second electrode 136 can be characterized by some or all of the following optical properties. According to an implementation of the liquid lens 200a-200c, the electrodes 134, 136 can comprise a reflectivity minimum of about 3% or less at a visible wavelength within a range of 390 nm to 700 nm. In some embodiments, the electrodes 134, 136 can comprise a reflectivity minimum of about 3% or less, 2.5% or less, 2% or less, 1.5% or less, 1% or less, 0.5% or less, and all reflectivity minima between these values, as measured at a visible wavelength. Further, the electrodes 134, 136 of the disclosure with such low reflectivity levels in the visible spectrum help minimize stray optical reflections within the cone and aperture of the liquid lenses 200a-200c that could otherwise degrade optical performance of the lens. In some implementations of the liquid lenses 200a-200c, the electrodes 134, 136 can comprise a reflectivity of about 25% or less at an ultraviolet (UV) wavelength within a range of 100 nm to 400 nm. In some embodiments, the electrodes 134, 136 can comprise a reflectivity of about 25% or less, 20% or less, 15% or less, 10% or less, 5% or less, 1% or less, and all reflectivity values between these limits, as measured at a UV wavelength. Also, the electrodes 134, 136 of the disclosure with these low reflectivity levels in the UV spectrum are a factor in ensuring that laser processes can be employed effectively to bond the substrates 108, 110, and/or 112 together, particularly with a UV laser. In particular, these low reflectivity levels in the electrodes 134, 136 reduce the laser input energy for bonding, which can also reduce temperature increases, particularly in proximity to the liquids 124, 126. According to some embodiments of the liquid lens 200a-200c, the electrodes 134, 136 can comprise an optical transmittance of at least about 70% at an infrared (IR) wavelength within a range of 800 nm to 1700 nm. In embodiments, the electrodes 134, 136 can comprise an optical transmittance of at least about 70%, 75%, 80%, 85%, 90%, 95%, and all optical transmittance levels between these values, as measured at an IR wavelength.

Once again referring to the liquid lenses 200a-200c depicted in FIGS. 2A-2C, either or both of the first electrode 134 and the second electrode 136 can be characterized by some or all of the following electrical properties. According to an implementation of the liquid lenses 200a-200c, the electrodes 134, 136 can comprise a sheet resistance from about 5 Ω/sq to about 0.5 Ω/sq. In some implementations of the liquid lenses 200a-200c, the electrodes 134, 136 can comprise a sheet resistance of about 5 Ω/sq, 4.5 Ω/sq, 4.0 Ω/sq, 3.5 Ω/sq, 3.0 Ω/sq, 2.5 Ω/sq, 2.0 Ω/sq, 1.5 Ω/sq, 1.0 Ω/sq, 0.5 Ω/sq, and all sheet resistance values between these sheet resistance levels. With these sheet resistance levels, the electrodes 134, 136 have current carrying capability to allow for the induced voltage variations associated with proper operation of the device employing the liquid lenses 200a-200c. These sheet resistance levels in the electrodes 134, 136 are also at a level that heater electrodes (e.g., resistance-heater electrodes) patterned from them can be configured to heat the device employing the liquid lenses 200a-200c to improve operation under low (e.g., sub-zero) temperature evolutions.

Still referring to the liquid lenses 200a-200c depicted in FIGS. 2A-2C, the second electrode 136 can be insulated from the first liquid 124 and the second liquid 126 via the insulating layer 140. The insulating layer 140 can comprise an insulating coating applied to the first substrate 112 before attaching the second substrate 108 and/or the third substrate 110 to the first substrate 112. The insulating layer 140 can comprise an insulating coating applied to the second electrode 136 after attaching the third substrate 110 to the first substrate 112 and before attaching the second substrate 108 to the first substrate 112. Thus, the insulating layer 140 covers at least a portion of the second electrode 136 within the cavity 122. The insulating layer 140 can cover at least a portion of the second electrode 136 (acting as the driving electrode) (e.g., the portion of the second electrode 136 disposed within the cavity 122) to insulate the first liquid 124 and the second liquid 126 from the second electrode 136. Additionally, or alternatively, at least a portion of the first electrode 134 (acting as the common electrode) disposed within the cavity 122 is uncovered by the insulating layer 140. Thus, the first electrode 134 can be in electrical communication with the first liquid 124 as described herein.

The liquid lenses 200a-200c depicted in FIGS. 2A-2C can include one or more apertures through the second substrate 108. The apertures comprise portions of the liquid lens at which the first electrode 134 is exposed through the second substrate 108, such as via removal of a portion of the second substrate 108 or otherwise. Thus, the apertures are configured to enable electrical connection to the first electrode 134, e.g., at the first interconnection 32. Further, the regions of the first electrode 134 exposed at the apertures can serve as contacts to enable electrical connection of the liquid lens to a controller, a driver, or another component of a lens or camera system (not shown). In other words, the apertures provide an electrical contact point between the liquid lens and another electrical device. As outlined earlier, the interconnection 32 can be capacitive in nature (e.g., as in liquid lens 200a, 200b shown in FIGS. 2A-2B) or it can be resistive in nature with a direct electrical connection (e.g., as in liquid lens 200c shown in FIG. 2C).

Likewise, the liquid lenses 200a-200c depicted in FIGS. 2A-2C can also comprise one or more apertures through the third substrate 110, according to some embodiments. These apertures comprise portions of the liquid lens 200a-200c at which the second electrode 136 is exposed through the third substrate 110, such as via removal of a portion of the third substrate 110 or otherwise. Thus, the apertures are configured to enable electrical connection to the second electrode 136, e.g., at the second interconnection 34. Further, the regions of the second electrode 136 exposed at the apertures can serve as contacts to enable electrical connection of the liquid lens to a controller, a driver, or another component of a lens or camera system (not shown). As outlined earlier, the interconnection 34 can be capacitive in nature (e.g., as in liquid lens 200a shown in FIG. 2A) or it can be resistive in nature with a direct electrical connection (e.g., as in liquid lens 200b, 200c shown in FIGS. 2B, 2C).

Referring again to the liquid lenses 200a-200c depicted in FIGS. 2A-2C, the prior-described apertures (not shown) provide an electrical contact point between the liquid lens and another electrical device. Different voltages can be supplied to the first electrode 134 and the second electrode 136 via the apertures (and the attendant interconnections) to change the shape of the interface between the first and second liquids 124, 126, a process referred to as electrowetting. For example, applying a voltage to increase or decrease the wettability of the surface of the cavity 122 with respect to the first liquid 124 can change the shape of the interface with the second liquid 126. Changing the shape of the interface can change the focal length or focus of the liquid lens. For example, such a change of focal length can enable the liquid lens to perform an ‘autofocus’ function. Additionally, or alternatively, adjusting the interface between the liquids 124, 126 can tilt the interface relative to the optical axis (not shown) of the liquid lens 100. For example, such tilting can enable the liquid lens 200a-200c to perform an optical image stabilization (OIS) function. Adjusting the interface can be achieved without physical movement of the liquid lens relative to an image sensor, a fixed lens or lens stack, a housing, or other components of a camera module in which the liquid lens can be incorporated.

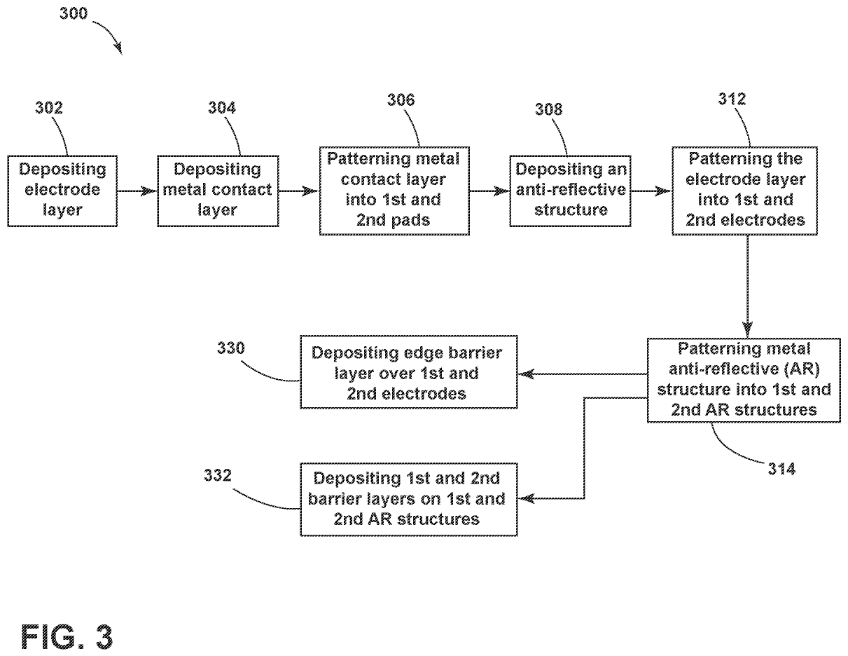

Referring now to FIG. 3, a method 300 of making a liquid lens article (e.g., liquid lens articles 100 and 100a-c depicted in FIGS. 1-2C) is provided. The method 300 includes a step 302 of depositing an electrode layer on a first and second primary surface of a first substrate (e.g., first substrate 112), the first substrate comprising a glass composition and the second primary surface opposing the first primary surface. The method 300 also includes a step 312 of patterning the electrode layer to define a first and a second electrode (e.g., first and second electrodes 134, 136) disposed on the respective first or second primary surface of the substrate, wherein each of the first electrode and the second electrode comprises an outer edge (e.g., outer edges 134a, 136a). The method 300 further includes a step 330 of depositing an edge barrier layer (e.g., edge barrier layer 50) over the first and second electrode, wherein the barrier layer substantially covers the outer edge of the electrodes. According to the method 300, each electrode (e.g., electrodes 134, 136) comprises a metal. The edge barrier layer (e.g., edge barrier layer 50) comprises an electrically insulating metal oxide or oxynitride. Further, the metal of each electrode is selected from the group consisting of Cr, Mo, Au, Ag, Ni, Ti, Cu, Al, V, W, Zr, indium tin oxide (ITO), indium zinc oxide (IZO), a Ni/V alloy, a Ni/Au alloy, a Au/Si alloy, a Cu/Ni alloy, other alloys thereof, and combinations thereof.

According to implementations of the method 300 depicted in FIG. 3 of making a liquid lens article (e.g., liquid lens articles 100 and 100a-c depicted in FIGS. 1-2C), the method can further include a step 308 of depositing an AR structure on the electrode layer (e.g., as formed in step 302); and a step 314 of patterning the AR structure to define a first AR structure and a second AR structure (e.g., AR structures 144, 146) on the respective first and second electrodes. According to this implementation, each of the first and second AR structures formed in steps 308 and 314 includes a metal layer and a metal oxide layer. In some embodiments of the method 300 depicted in FIG. 3, the method can further include a step 332 of depositing a first barrier layer and a second barrier (e.g., first and second barrier layers 154, 156) on the respective first and second AR structures. According to this implementation, each of the first and second barrier layers formed in step 332 includes an electrically insulating metal oxide or oxynitride.

According to another implementation of the method 300 depicted in FIG. 3 of making a liquid lens article (e.g., liquid lens articles 100 and 100a-c depicted in FIGS. 1-2C), the method can further include a step 304 of depositing a metal contact layer over the electrode layer (e.g., as formed in step 302). This implementation further includes a step 306 of patterning the metal contact layer to define a metal contact pad (e.g., metal contact pads 22, 24) over each of the first and second electrodes (first and second electrodes 134, 136). In this implementation, each metal contact pad (e.g., metal contact pads 22, 24) includes one or more of Au, Ag, Pt, Cu, Ti/Au, Cr/Au, alloys thereof, a metal conductive epoxy, and combinations thereof.

### EXAMPLES

The following example describes various features and advantages provided by the disclosure, and are in no way intended to limit the disclosure and appended claims.

### Example 1

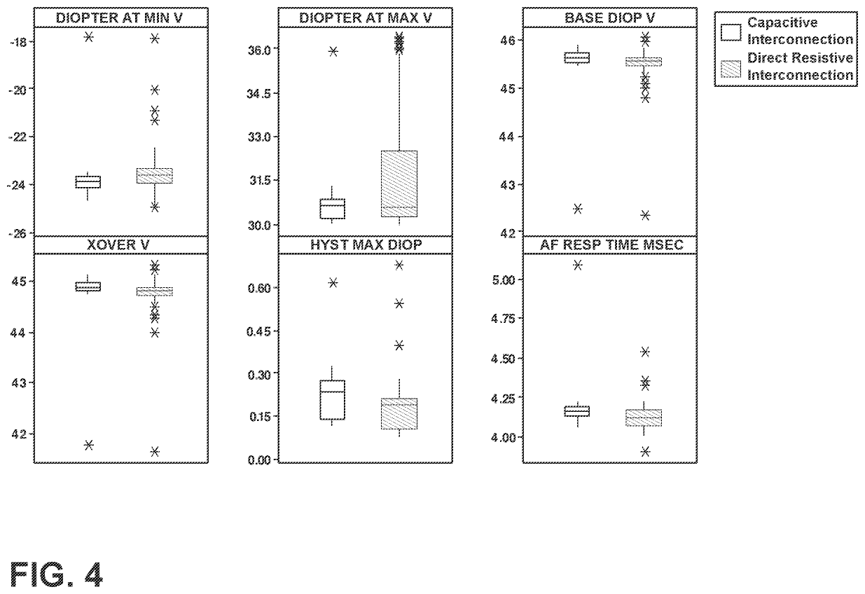

In this example, two liquid lenses were fabricated and subjected to various liquid lens parameter measurements, as show in the box plots of FIG. 4. One liquid lens was fabricated with a set of capacitive interconnections, as consistent with the principles of the disclosure (e.g., the liquid lens 200a depicted in FIG. 2A) and denoted “Capacitive Interconnection” in FIG. 4. A second liquid lens with a set of direct, resistive interconnections was fabricated, as consistent with the principles of the disclosure (e.g., the liquid lens 200c depicted in FIG. 2C) and denoted “Direct Resistive Interconnection” in FIG. 4. Both sets of liquid lenses were fabricated with electrodes that include a Cr layer having a thickness of 110 nm, and AR structures with a CrOₓN_{y} layer having a thickness of 45 nm. After the third substrate was bonded to the first substrate, the assembly was coated with an adhesion/barrier layer of Al₂O₃ having a thickness of 50 nm and a parylene insulating layer having a thickness of 2200 nm. The assembly was then subjected to patterning, and then the second substrate was bonded to the first substrate. At this point, interconnections were made for the “Capacitive Interconnection” group. As for the “Direct Resistive Interconnection” group, these samples were subjected to wet etching of the Al₂O₃ layer, exposing the CrOₓN_{y} layer on the contact pads. At this point, the CrOₓN_{y} layer was ablated to expose the underlying Cr contact pad to facilitate a direct, resistive interconnection.

As demonstrated by FIG. 4, various liquid lens parameters are depicted in the box plots, i.e., diopter at minimum driving voltage (“Diopter_at_min_V”), diopter at maximum driving voltage (“Diopter_at_max_V), diopter at base voltage (“Base_diop_V”), cross-over voltage (“Xover_V”), hysteresis at the maximum diopter (“Hyst_max_diop”), and autofocus response time (“AF_resp_time_msec”). As is evident from the data shown in FIG. 4, no significant performance differences were exhibited by the two liquid lenses of this example, indicating that both capacitive and direct, resistive interconnection schemes do not significantly influence liquid lens performance criteria.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

According to a first aspect, a liquid lens article is provided. The liquid lens article comprises: a first substrate comprising a glass composition; a first electrode disposed on a first primary surface of the first substrate; and a second electrode disposed on a second primary surface of the first substrate, the second primary surface opposing the first primary surface, wherein each of the first electrode and the second electrode comprises an outer edge that is substantially covered by an edge barrier layer, wherein each electrode comprises a metal, and further wherein the edge barrier layer comprises an electrically insulating metal oxide or oxynitride.

According to a second aspect, the first aspect is provided, wherein the metal of each electrode is selected from the group consisting of Cr, Mo, Au, Ag, Ni, Ti, Cu, Al, V, W, Zr, indium tin oxide (ITO), indium zinc oxide (IZO), a Ni/V alloy, a Ni/Au alloy, a Au/Si alloy, a Cu/Ni alloy, other alloys thereof, and combinations thereof.

According to a third aspect, the first or second aspect is provided, further comprising: a metal contact pad disposed over each of the first and second electrodes, each metal contact pad comprising one or more of Au, Ag, Pt, Cu, Ti/Au, Cr/Au, alloys thereof, a metal conductive epoxy, and combinations thereof.

According to a fourth aspect, any one of the first through third aspects is provided, further comprising: a first antireflective structure disposed on the first electrode; a second antireflective structure disposed on the second electrode; a first barrier layer disposed on the first antireflective structure; and a second barrier layer disposed on the second antireflective structure.

According to a fifth aspect, the fourth aspect is provided, wherein each of the first and second antireflective structures comprises a metal layer and a metal oxide layer, and further wherein each of the first and second barrier layers comprises an electrically insulating metal oxide or oxynitride.

According to a sixth aspect, any one of the first through third aspects is provided, further comprising: a first antireflective structure disposed on the first electrode; and a first barrier layer disposed on the first antireflective structure.

According to a seventh aspect, the sixth aspect is provided, wherein the first antireflective structure comprises a metal layer and a metal oxide layer, and further wherein the first barrier layer comprises an electrically insulating metal oxide or oxynitride.

According to an eighth aspect, any one of the first through third aspects is provided, further comprising: a first antireflective structure disposed on the first electrode; a second antireflective structure disposed on the second electrode; and a first barrier layer disposed on the first antireflective structure.

According to a ninth aspect, the eighth aspect is provided, wherein each of the first and second antireflective structures comprises a metal layer and a metal oxide layer, and further wherein the first barrier layer comprises an electrically insulating metal oxide or oxynitride.

According to a tenth aspect, a liquid lens is provided. The liquid lens comprises: a first substrate comprising a glass composition; a first electrode disposed on a first primary surface of the first substrate; a second electrode disposed on a second primary surface of the first substrate, the second primary surface opposing the first primary surface; a second substrate comprising a bore and bonded to the first substrate at a bond defined at least in part by the first electrode; a cavity defined at least in part by the bore in the second substrate, the bond, and the first substrate; and a first liquid and a second liquid disposed within the cavity, wherein each of the first electrode and the second electrode comprises an outer edge that is substantially covered by an edge barrier layer, wherein each electrode comprises a metal, and further wherein the edge barrier layer comprises an electrically insulating metal oxide or oxynitride.

According to an eleventh aspect, the tenth aspect is provided, wherein the metal of each electrode is selected from the group consisting of Cr, Mo, Au, Ag, Ni, Ti, Cu, Al, V, W, Zr, IZO, ITO, a Ni/V alloy, a Ni/Au alloy, a Au/Si alloy, a Cu/Ni alloy, other alloys thereof, and combinations thereof.

According to a twelfth aspect, the tenth or eleventh aspect is provided, further comprising: a metal contact pad disposed near the outer edge of each of the first and second electrodes and in electrical communication with the respective first or second electrode, each metal contact pad comprising one or more of Au, Ag, Pt, Cu, Ti/Au, Cr/Au, alloys thereof, a metal conductive epoxy, and combinations thereof.

According to a thirteenth aspect, any one of the tenth through twelfth aspects is provided, further comprising: a first antireflective structure disposed on the first electrode; a second antireflective structure disposed on the second electrode; a first barrier layer disposed on the first antireflective structure; and a second barrier layer disposed on the second antireflective structure.

According to a fourteenth aspect, the thirteenth aspect is provided, wherein each of the first and second antireflective structures comprises a metal layer and a metal oxide layer, and further wherein each of the first and second barrier layers comprises an electrically insulating metal oxide or oxynitride.

According to a fifteenth aspect, the thirteenth or fourteenth aspect is provided, further comprising: a first interconnection to a portion of the first electrode through the first antireflective structure and the first barrier layer; and a second interconnection to a portion of the second electrode through the second antireflective structure and the second barrier layer, wherein each of the first and second interconnections comprises a capacitive coupling between a conductive epoxy and the respective first or second electrode.

According to a sixteenth aspect, any one of the tenth through thirteenth aspects is provided, further comprising: a first antireflective structure disposed on the first electrode; and a first barrier layer disposed on the first antireflective structure.

According to a seventeenth aspect, the sixth aspect is provided, wherein the first antireflective structure comprises a metal layer and a metal oxide layer, and further wherein the first barrier layer comprises an electrically insulating metal oxide or oxynitride.

According to an eighteenth aspect, the sixteenth or seventh aspect is provided, further comprising: a first interconnection to a portion of the first electrode through the first antireflective structure and the first barrier layer; and a second interconnection joined to a portion of the second electrode, wherein the first interconnection comprises a capacitive coupling between a conductive epoxy and the first electrode and the second interconnection comprises a resistive, direct coupling between a conductive epoxy and the second electrode.

According to a nineteenth aspect, any one of the tenth through thirteenth aspects is provided, further comprising: a first antireflective structure disposed on the first electrode; a second antireflective structure disposed on the second electrode; and a first barrier layer disposed on the first antireflective structure.

According to a twentieth aspect, the nineteenth aspect is provided, wherein each of the first and second antireflective structures comprises a metal layer and a metal oxide layer, and further wherein the first barrier layer comprises an electrically insulating metal oxide or oxynitride.

According to a twenty-first aspect, the nineteenth or twentieth aspect is provided, further comprising: a first interconnection joined to a portion of the first electrode through the first antireflective structure and the first barrier layer; and a second interconnection joined to a portion of the second electrode through the second antireflective structure, wherein each of the first and second interconnections comprises a direct, resistive coupling between a conductive epoxy and the respective first or second electrode.

According to a twenty-second aspect, a method of making a liquid lens article is provided. The method comprises: depositing an electrode layer on a first and second primary surface of a first substrate comprising a glass composition, the second primary surface opposing the first primary surface; patterning the electrode layer to define a first and a second electrode disposed on the respective first or second primary surface of the substrate, wherein each of the first electrode and the second electrode comprises an outer edge; and depositing an edge barrier layer over the first and second electrode, wherein the barrier layer substantially covers the outer edge of the electrodes, wherein each electrode comprises a metal, wherein the edge barrier layer comprises an electrically insulating metal oxide or oxynitride, and further wherein the metal of each electrode is selected from the group consisting of Cr, Mo, Au, Ag, Ni, Ti, Cu, Al, V, W, Zr, indium tin oxide (ITO), indium zinc oxide (IZO), a Ni/V alloy, a Ni/Au alloy, a Au/Si alloy, a Cu/Ni alloy, other alloys thereof, and combinations thereof.

According to a twenty-third aspect, the twenty-second aspect is provided, further comprising: depositing an antireflective structure on the electrode layer; and patterning the antireflective structure to define a first and a second antireflective structure disposed on the respective first or second electrode, wherein each of the first and second antireflective structure comprises a metal layer and a metal oxide layer.

According to a twenty-fourth aspect, the twenty-third aspect is provided, further comprising: depositing a first barrier layer and a second barrier layer on the respective first or second antireflective structure, wherein each of the first and second barrier layers comprises an electrically insulating metal oxide or oxynitride.

According to a twenty-fifth aspect, any one of the twenty-second to twenty-fourth aspects is provided, further comprising: depositing a metal contact layer over the electrode layer; and patterning the metal contact layer to define a metal contact pad over each of the first and second electrodes, each metal contact pad comprising one or more of Au, Ag, Pt, Cu, Ti/Au, Cr/Au, alloys thereof, a metal conductive epoxy, and combinations thereof

What is claimed is:

1. A liquid lens article, comprising:
a first substrate comprising a glass composition;
a first electrode disposed on a first primary surface of the first substrate; and
a second electrode disposed on a second primary surface of the first substrate, the second primary surface opposing the first primary surface,
wherein each of the first electrode and the second electrode comprises an outer edge that is substantially covered by an edge barrier layer,
wherein each electrode comprises a metal, and
further wherein the edge barrier layer comprises an electrically insulating metal oxide or oxynitride.

2. The article of claim 1, wherein the metal of each electrode is selected from the group consisting of Cr, Mo, Au, Ag, Ni, Ti, Cu, Al, V, W, Zr, indium tin oxide (ITO), indium zinc oxide (IZO), a Ni/V alloy, a Ni/Au alloy, a Au/Si alloy, a Cu/Ni alloy, other alloys thereof, and combinations thereof.

3. The article of claim 1, further comprising:
a metal contact pad disposed over each of the first and second electrodes, each metal contact pad comprising one or more of Au, Ag, Pt, Cu, Ti/Au, Cr/Au, alloys thereof, a metal conductive epoxy, and combinations thereof.

4. The article of claim 1, further comprising:
a first antireflective structure disposed on the first electrode;
a second antireflective structure disposed on the second electrode;
a first barrier layer disposed on the first antireflective structure; and
a second barrier layer disposed on the second antireflective structure.

5. The article of claim 4, wherein each of the first and second antireflective structures comprises a metal layer and a metal oxide layer, and further wherein each of the first and second barrier layers comprises an electrically insulating metal oxide or oxynitride.

6. The article of claim 1, further comprising:
a first antireflective structure disposed on the first electrode; and
a first barrier layer disposed on the first antireflective structure.

7. The article of claim 6, wherein the first antireflective structure comprises a metal layer and a metal oxide layer, and further wherein the first barrier layer comprises an electrically insulating metal oxide or oxynitride.

8. The article of claim 1, further comprising:
a first antireflective structure disposed on the first electrode;
a second antireflective structure disposed on the second electrode; and
a first barrier layer disposed on the first antireflective structure.

9. The article of claim 8, wherein each of the first and second antireflective structures comprises a metal layer and a metal oxide layer, and further wherein the first barrier layer comprises an electrically insulating metal oxide or oxynitride.

10. A liquid lens, comprising:
a first substrate comprising a glass composition;
a first electrode disposed on a first primary surface of the first substrate;
a second electrode disposed on a second primary surface of the first substrate, the second primary surface opposing the first primary surface;
a second substrate comprising a bore and bonded to the first substrate at a bond defined at least in part by the first electrode;
a cavity defined at least in part by the bore in the second substrate, the bond, and the first substrate; and
a first liquid and a second liquid disposed within the cavity,
wherein each of the first electrode and the second electrode comprises an outer edge that is substantially covered by an edge barrier layer,
wherein each electrode comprises a metal, and
further wherein the edge barrier layer comprises an electrically insulating metal oxide or oxynitride.

11. The liquid lens of claim 10, further comprising:
a metal contact pad disposed near the outer edge of each of the first and second electrodes and in electrical communication with the respective first or second electrode, each metal contact pad comprising one or more of Au, Ag, Pt, Cu, Ti/Au, Cr/Au, alloys thereof, a metal conductive epoxy, and combinations thereof.

12. The liquid lens of claim 10, further comprising:
a first antireflective structure disposed on the first electrode;
a second antireflective structure disposed on the second electrode;
a first barrier layer disposed on the first antireflective structure; and
a second barrier layer disposed on the second antireflective structure.

13. The liquid lens of claim 12, further comprising:
a first interconnection to a portion of the first electrode through the first antireflective structure and the first barrier layer; and
a second interconnection to a portion of the second electrode through the second antireflective structure and the second barrier layer,
wherein each of the first and second interconnections comprises a capacitive coupling between a conductive epoxy and the respective first or second electrode.

14. The liquid lens of claim 10, further comprising:
a first antireflective structure disposed on the first electrode; and
a first barrier layer disposed on the first antireflective structure.

15. The liquid lens of claim 14, further comprising:
a first interconnection to a portion of the first electrode through the first antireflective structure and the first barrier layer; and
a second interconnection joined to a portion of the second electrode,
wherein the first interconnection comprises a capacitive coupling between a conductive epoxy and the first electrode and the second interconnection comprises a resistive, direct coupling between a conductive epoxy and the second electrode.

16. The liquid lens of claim 10, further comprising:
a first antireflective structure disposed on the first electrode;
a second antireflective structure disposed on the second electrode; and
a first barrier layer disposed on the first antireflective structure.

17. The liquid lens of claim 16, further comprising:
a first interconnection joined to a portion of the first electrode through the first antireflective structure and the first barrier layer; and
a second interconnection joined to a portion of the second electrode through the second antireflective structure,
wherein each of the first and second interconnections comprises a direct, resistive coupling between a conductive epoxy and the respective first or second electrode.

18. A method of making a liquid lens article, the method comprising:
depositing an electrode layer on a first and second primary surface of a first substrate comprising a glass composition, the second primary surface opposing the first primary surface;
patterning the electrode layer to define a first and a second electrode disposed on the respective first or second primary surface of the substrate, wherein each of the first electrode and the second electrode comprises an outer edge; and
depositing an edge barrier layer over the first and second electrode, wherein the barrier layer substantially covers the outer edge of the electrodes,
wherein each electrode comprises a metal,
wherein the edge barrier layer comprises an electrically insulating metal oxide or oxynitride, and
further wherein the metal of each electrode is selected from the group consisting of Cr, Mo, Au, Ag, Ni, Ti, Cu, Al, V, W, Zr, indium tin oxide (ITO), indium zinc oxide (IZO), a Ni/V alloy, a Ni/Au alloy, a Au/Si alloy, a Cu/Ni alloy, other alloys thereof, and combinations thereof.

19. The method of claim 18, further comprising:
depositing an antireflective structure on the electrode layer;
patterning the antireflective structure to define first and a second antireflective structures disposed on the respective first and second electrodes; and
depositing first and second barrier layers on the respective first and second antireflective structures,
wherein each of the first and second antireflective structures comprises a metal layer and a metal oxide layer, and
wherein each of the first and second barrier layers comprises an electrically insulating metal oxide or oxynitride.

20. The method of claim 18, further comprising:
depositing a metal contact layer over the electrode layer; and
patterning the metal contact layer to define a metal contact pad over each of the first and second electrodes, each metal contact pad comprising one or more of Au, Ag, Pt, Cu, Ti/Au, Cr/Au, alloys thereof, a metal conductive epoxy, and combinations thereof.
